(19) United States
(12) Patent Application Publication
(10) Pub. No.: US 2025/0273389 A1
(43) Pub. Date: Aug. 28, 2025

(54) COUPLED INDUCTOR AND VOLTAGE REGULATOR

(71) Applicant: TDK Electronics AG, Muenchen (DE)

(72) Inventors: Felipe Jerez Galdeano, Thalfingen-Elchingen (DE); Joachim Sorg, Schwaebisch Gmuend (DE); Anneliese Drespling, Heidenheim (DE)

(21) Appl. No.: 18/859,900

(22) PCT Filed: Apr. 26, 2023
(86) PCT No.: PCT/EP2023/060923

§ 371 Date: Oct. 24, 2024

(30) Foreign Application Priority Data
Apr. 29, 2022 (DE) 102022110526.1

(51) Int. Cl. H01F 27/32; G05F 1/33; H01F 27/02; H01F 27/255

(52) U.S. Cl. CPC H01F 27/323; H01F 27/022; H01F 27/255; G05F 1/33

(57) ABSTRACT

In an embodiment a coupled inductor includes a body having a first material, a first winding and a second winding magnetically coupled to the first winding and electrically isolated from the first winding, wherein the first winding and the second winding are embedded in the first material of the body, wherein the first material provides a magnetic surrounding of the first winding and the second winding, wherein the first winding has m turns with m>1, and wherein the second winding has n turns with n>1.

### CROSS-REFERENCE TO RELATED APPLICATIONS

This patent application is a national phase filing under section 371 of PCT/EP2023/060923, filed Apr. 26, 2023, which claims the priority of German patent application 102022110526.1, filed Apr. 29, 2022, each of which is incorporated herein by reference in its entirety.

### TECHNICAL FIELD

The present invention refers to coupled inductors, e.g. coupled inductors for use in voltage regulators such as trans-inductance voltage regulators (TLVRs).

### BACKGROUND

Trans-inductor voltage regulators provide the possibility to have high current and fast transient response (e.g. due to a change in the load) for applications, e.g. power applications, such as power sources for ASICs, GPUs, CPUs and FPGAs in datacenters, servers and storage centers.

Trans-inductor voltage regulators are known from WO 2021/12 13 801 A1.

Conventional voltage regulators (VR) are implemented with typical multiphase buck topology systems using low inductance, drivers and high current inductors in every phase. The ripple current at the converter output is reduced due to the contribution of every inductor, so that total ripple is n-times smaller than the ripple in every phase. The system can respond to a change in the load depending on the number of phases and the stability of the control loop.

This tradeoff can be difficult to achieve due to the relatively large space needed in the PCB to allocate more phases and because the inductance value is reduced to levels of 100 nH introducing more ripple current.

This space constraint is one reason why the current ferrite inductors may usually have small footprints but high vertical profiles, which introduces further problems concerning the mechanical stability of the coils, even during PCB placement.

Capacitors used in conventional voltage regulators can be chosen to have high capacities in order to stabilize the control loop.

Further, high ripple currents introduce higher AC losses and make the converter control more complicated as every phase is usually reacting to load changes with variations of the duty cycle.

### SUMMARY

To improve the behavior of corresponding systems it is possible to use a Trans-Inductor Voltage Regulator or TLVR topology that increase the bandwidth and the response time. With this system single inductors are replaced by dual inductors with a high coupling and an equally low inductance value. The first winding or primary winding can be used in the same way as the standard voltage regulators and the secondary windings can be connected in series with a compensation inductor and finally connected to ground. This compensation inductor is introduced to adjust the total inductance of a secondary loop to make the converter more stable. AC losses of this inductor should be as low as possible in order to avoid excessive overheating due to the superposition of every phase ripple.

With such topologies the changes made by every phase to comply with power needs are immediately detected by the secondary side and transferred to the primary side due to a high coupling factor. This is the reason why all phases can respond simultaneously to a load transient such that the response time to a load change is improved. Due to the reduced transient response, the need for large (corresponding to a high capacity) output capacitors is reduced in TLVRs.

TLVRs benefit from a dual inductor with high coupling, low inductance value, high isolation, a high saturation level and small spatial dimensions.

However, typical inductor solutions offered for use in TLVRs are implemented with MnZn (manganese-Zinc) ferrite cores, two copper frames with U-shape to achieve low DC resistance, a primary winding and a secondary winding and an isolation tape there between.

However, in view of these known inductors there is the wish for smaller spatial dimensions, a soft saturation performance (specifically at higher temperatures), simplicity in application, e.g. at SMD connections, good mechanical stability, small footprint and reduced vertical height, a high current level and a sufficient and thermodynamically stable isolation between the primary side and the secondary side.

To that end, an improved coupled inductor according to the independent claim and a corresponding voltage regulator are provided. Dependent claims provide preferred embodiments.

The coupled inductor comprises a body, a first winding and a second winding. The body comprises a first material. The second winding is magnetically coupled to the first winding and electrically isolated from the first winding. The first winding and the second winding are embedded in the first material of the body. The first material provides a magnetic surrounding of the first winding and of the second winding. Further, the first winding has m turns with m>1. Further, the second winding has n turns with n>1.

With such a configuration of windings arranged relative to one another and embedded in the material of the body and with the corresponding turns of the windings, the coupled inductor can have-for a given electrical performance-smaller spatial dimensions, a soft saturation performance, specifically at higher temperatures, a good mechanical stability, small footprint and a reduced vertical height, a high current level and a sufficient and thermodynamically stable isolation between the primary side and the secondary side, while at the same time enabling a simple application, e.g. as an SMD component (SMD=surface mounted device).

It is possible that the first winding and/or the second winding has a helix structure.

With a helix structure for the first winding and/or for the second winding the corresponding winding essentially establishes a cylindrical coil having an elongation direction and having an essentially constant radius of the turns of the windings.

It is possible that the number n and m for the turns of the first winding and/or for the turns of the second winding is 3. It is possible that the first winding and the second winding establish a double helix structure, in particular when both windings have a corresponding helix structure.

Such a structure is essentially obtained when both windings share a common winding axis along the longitudinal direction such that individual turns of one winding are arranged next to individual turns of the corresponding other winding.

Then, magnetic flux—when a corresponding winding is applied with the current—penetrates the corresponding turns of the respective other winding such that the magnetic coupling between the first winding and the second winding is obtained. In particular, a specifically high magnetic coupling between the two windings can be obtained.

It is possible that the first winding and/or the second winding is coated with a material selected from a dielectric material such as parylene.

Then, sufficient electric isolation between the two windings of the coil structure is obtained. In particular, it is possible that the corresponding coating can withstand a voltage of 1 kV or more.

It is possible the first winding and/or the second winding comprises or consists of a material selected from Cu (copper), Ag (silver), Al (aluminum), Au (gold).

However, other conventional materials for the conducting structures of inductors are possible too.

It is possible that the first winding and/or the second winding is coated with a material having a thickness t with 3 μm≤t≤5 μm.

A coating of one of the above-mentioned materials with a thickness in this interval provides the necessary isolation to withstand the above-mentioned voltages.

It is possible that a turn of the first winding and/or a turn of the second winding has an inductance L with 10 nH≤L≤220 nH.

Specifically, a coupled inductor with a coil structure with n=m=3 turns per winding, the first winding and the second winding can have total inductances between 30 nH and 660 nH.

It is possible that the width of the winding, e.g. of the first winding and/or the second winding, varies along a longitudinal axis of the corresponding winding.

Thus, the thickness of the conducting material of the corresponding winding has a different cross-section where the cross-section depends on the longitudinal position of the winding.

It is further possible that the width of the winding that depends on the longitudinal position is symmetrical with respect to a symmetry plane orthogonal to the longitudinal extension direction of the windings. Thus, when the first winding has a section of the wide cross-section of the conducting material at one distal end of the double helix structure, then the corresponding other winding has the corresponding width at the respective other distal end of the long extension of the windings.

It is possible that the magnetic coupling factor between the first winding and the second winding is 99% or higher. Specifically, it is possible that the magnetic coupling factor is between 99.5% and 99.9%.

It is possible that the body has an elongated shape with a first distal end and a second distal end arranged opposite to the first distal end with respect to the elongated shape. The first winding has a first connection at the first distal end. Further, the first winding has a second connection at the second distal end. Additionally the second winding has a first connection at the first distal end and a second connection at the second distal end.

Thus, it is possible that the first connection of the first winding and of the second winding are positioned at a first distal end of the elongated shape of the coil structure or of the body while the respective second connections of the first winding and of the second winding are arranged at the second, opposite distal end of the body.

The above features relate to the longitudinal position along the elongated shape of the body and/or of the coil structure. However, with respect to the vertical position, it is possible that all connections of the windings are arranged at a same vertical position which may be a bottom position at a bottom side of the coupled inductor.

In particular, it is possible that the connections of the windings are arranged at the bottom side of the coupled inductor such that the connections can be electrically and mechanically connected to an external circuit environment via SMD mounting technology processes.

Thus, the coupled inductor can have flat external connections at the corresponding distal ends of the bottom side of the body.

It is possible that the first winding and the second winding have maximum widths at opposite distal ends of the body.

This feature corresponds to the symmetric property stated above with respect to a symmetry plane orthogonal to the elongation direction of the windings.

It is possible that the first winding and the second winding are derived from a common inductance body separated into two pieces via a laser process.

Thus, during manufacturing it is possible to provide a common inductance body that is separated via a laser beam into the first winding and the second winding. In particular, it is possible that the distance between the first winding and the second winding is essentially constant for at least a longitudinal section of the coil structure. In this case, the distance between the two windings can be adjusted via the details of the laser cutting process such that a sufficient isolation can be obtained and such that the corresponding sufficient coating can be applied.

Accordingly, it is possible that the distance between the first winding and the second winding is d with 15 μm≤d≤50 μm.

Further, it is possible that the coupled inductor further comprises a magnetic core arranged within the first and/or second winding.

For such a configuration it is possible that the magnetic core comprises magnetic particles. The magnetic particles can be embedded in a matrix material.

It is possible that the magnetic core comprises metal particles. Further, it is possible that the dielectric material comprises or consists of a material selected from a dielectric material and an epoxy compound.

It is possible that the matrix material is disposed via a molding process.

Thus, conventional steps for embedding conductor structures in a mold material can be applied.

Further, it is possible that a coupled inductor as described above can be part of a voltage regulator.

Specifically, it is possible that the coupled inductor is used in a trans-inductor voltage regulator, TLVR.

Further, it is possible that such a voltage regulator can be provided for and adapted to regulate an electrical circuit selected from an ASIC (ASIC=application specific integrated circuit), a GPU (GPU=graphical processing unit), a CPU (CPU=central processing unit) and an FPGA (FPGA=field programmable gate array).

A coupled inductor as described above or a voltage regulator as described above can be used for sustainable currents up to 100 A. Further, the body of the coupled inductor can have spatial dimensions that fit into a cuboid of 12*6*6 mm³. Compared to conventional coupled inductors based on conventional windings and including conventional ferrite as a magnetic material, the volume needed for a given electrical performance can be reduced to a third of the volume of a conventional coupled inductor.

Further, the saturation current at 23° C. can be similar to the saturation current at 125° C. such that the temperature dependence of the coupled inductor is strongly reduced. Further, with the above-mentioned spatial dimensions with 12 mm corresponding to the longitudinal length of the body and 6 mm corresponding to the vertical height of the body, a small footprint and a low profile component is obtained that is mechanically stable when arranged on and mechanically connected to a circuit board such as a PCB (PCB=printed circuit board).

In particular the essentially monolithic winding structure comprising the two windings embedded in the matrix material provides a substantial increase in mechanical stability compared to conventional coupled inductors with a substantially larger vertical height.

### BRIEF DESCRIPTION OF THE DRAWINGS

Working principles and specific technical details of preferred embodiments are shown in the accompanying schematic figures.

FIG. 1 shows a perspective view onto a body B of the coupled inductor CI;

FIG. 2 shows a perspective view onto a bottom side BS of the coupled inductor CI;

FIG. 3 illustrates a perspective view of the arrangement of the windings within the body of the coupled inductor CI;

FIG. 4 shows a more detailed view of the two windings establishing the double helix structure;

FIG. 5 illustrates the double helix structure in a top view perspective; and

FIG. 6 shows circuit elements of an equivalent circuit diagram of a corresponding voltage regulator VR comprising a plurality of coupled inductors CI as stated above.

### DETAILED DESCRIPTION OF ILLUSTRATIVE EMBODIMENTS

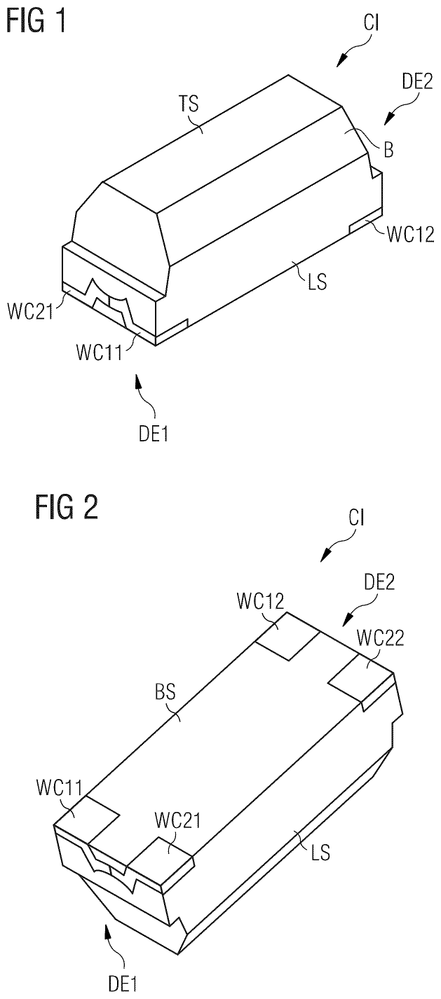

FIG. 1 shows a perspective view onto a coupled inductor CI. From an external view, the coupled inductor CI is essentially comprised of the body B, where the body B includes the internal circuit components, specifically the windings of the coupled inductor. The body B has a top side TS and a lateral side LS. Furthermore, the body B has an elongated shape with an elongation direction. The elongation direction essentially reaches from a first distal end DE1 to the opposite, second distal end DE2. The first distal end DE1 and the second distal end DE2 are essentially arranged at the opposite side surfaces of the body B that are not the top surface TS, the bottom side or side surfaces LS.

At corners or edges at the bottom surfaces at the distal ends DE1, DE2, winding connections WC are arranged such that the internal conductor structure can be electrically connected to an external circuit environment, e.g. via SMD techniques. Specifically, the body comprises a first winding connection of the first winding WC11 and a first winding connection of the second winding WC21 at the first distal end DE1. Further, the coupled inductor comprises a second winding connection of the first winding WC12 and a second winding connection of the second winding at the corresponding second distal end DE2.

At edges between the top side TS and the lateral sides LS chamfered edges can be provided such that handling is simplified and sharpness of edges is reduced.

FIG. 2 shows a perspective view of the corresponding coupled inductor CI showing the bottom side BS. At the bottom side at the first and second distal ends DE1, DE2 the corresponding surfaces of the winding connections WC11 to WC22 are arranged such that the coupled inductor can be electrically connected to an external circuit environment. It is to be noted that the winding connections of the two windings are electrically isolated such that there is no galvanic connection between the two windings. However, the actual distance between the corresponding winding connections at a distal end can be relatively small such that small footprints of circuit components of the coupled inductors are possible.

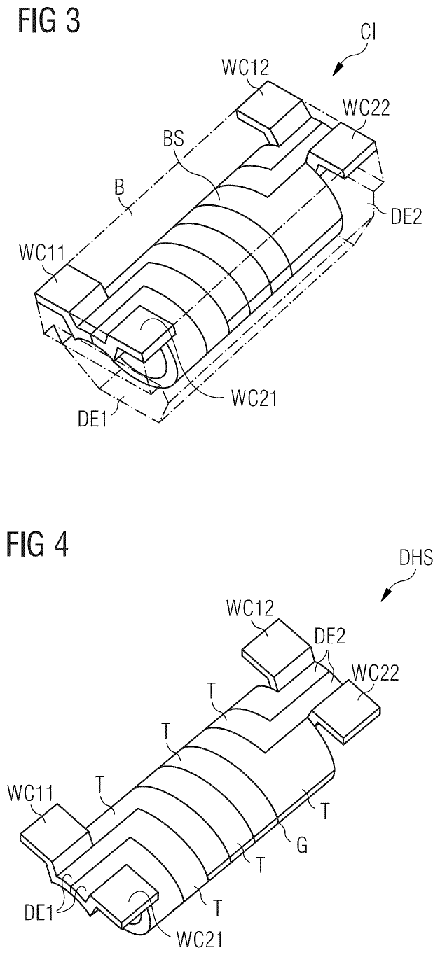

FIG. 3 illustrates a view onto the internal conductor structures establishing the first and the second winding and the corresponding arrangement of the conductor structures within the body B. A first winding with three turns is obtained between the first winding connection of the first winding WC11 and the second winding connection of the first winding WC12. A second winding is obtained and arranged via a conducting material arranged along a path between the first winding connection of the second winding WC21 and the second winding connection of the second winding WC22. Again, the distance between the two windings is small but large enough to obtain the necessary electric isolation.

FIG. 4 illustrates a view onto the combined arrangement of the first and the second winding. Each winding has three turns T and the turns of the windings are arranged relative to one another such that a double helix structure EHS is obtained between the winding connections WC arranged at the corresponding distal ends DE1, DE2.

The conductor structure shown in FIG. 4 can be obtained by providing a single conductor structure that is processed via a laser cutting process to mechanically separate the initially common structure into the later two separated and isolated windings. After the separation into two different pieces, the corresponding pieces can be coated with corresponding coating material. Thereafter, the material of the body and the material of the corresponding magnetic core can be applied via a mold process to obtain the final coupled inductor element.

FIG. 5 illustrates the winding structure shown in FIG. 4 from a top view perspective illustrating the tube-shaped double helix structure where the two single helix structures add up to establish the tube-shaped coupled inductors.

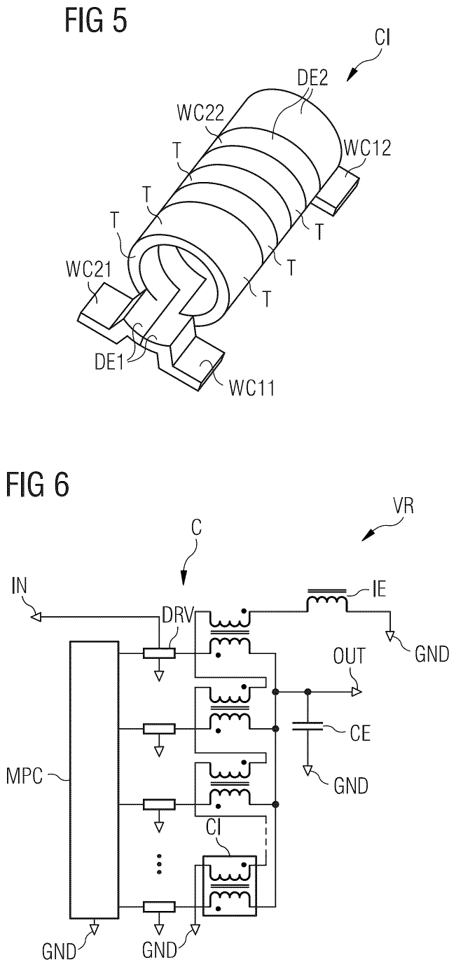

FIG. 6 illustrates circuit elements of a corresponding equivalent circuit diagram of a voltage regulator VR. The voltage regulator VR comprises a cascade C wherein each cascade stage comprises a driver DRV controlled by a multi-phase controller MPC and a coupled inductor CI electrically connected to the corresponding driver circuit DRV. Specifically, the primary side of each coupled inductor is electrically connected to the corresponding driver DRV while the secondary side of the coupled inductor CI is connected to an output port OUT which is connected to ground via a capacitance element CE. Further, the primary/secondary side of the coupled inductor of the first stage of the cascade C is electrically connected to ground via an inductance element IE.

Further, the multi-phase controller MPC is electrically connected to ground and to an input port IN.

Via such a voltage regulator establishing a trans-inductor voltage regulator, a highly efficient voltage regulation can be applied such that high currents can be handled and transient responses can be to reacted fast.

Overall ripples are reduced and the above-described advantageous effects can be obtained.

1.-21. (canceled)

22. A coupled inductor comprising:
a body comprising a first material;
a first winding; and
a second winding magnetically coupled to the first winding and electrically isolated from the first winding,
wherein the first winding and the second winding are embedded in the first material of the body,
wherein the first material provides a magnetic surrounding of the first winding and the second winding,
wherein the first winding has m turns with m>1, and
wherein the second winding has n turns with n>1.

23. The coupled inductor of claim 22, wherein at least one of the first winding or the second winding has a helix structure.

24. The coupled inductor of claim 22, wherein n=m=3.

25. The coupled inductor of claim 22, wherein the first winding and the second winding establish a double helix structure.

26. The coupled inductor of claim 22, wherein at least one of the first winding or the second winding is coated with a dielectric material.

27. The coupled inductor of claim 22, wherein at least one of the first winding or the second winding is coated with parylene.

28. The coupled inductor of claim 22, wherein at least one of the first winding or the second winding comprises or consists of a material selected from Cu, Ag, Al, or Au.

29. The coupled inductor of claim 22, wherein at least one of the first winding or the second winding is coated with a material having a thickness t with 3 μm≤t≤5 μm.

30. The coupled inductor of claim 22, wherein at least one of a turn of the first winding or a turn of the second winding has an inductance L with 10 nH≤L≤220 nH.

31. The coupled inductor of claim 22, wherein a width of the winding varies along a longitudinal axis of the winding.

32. The coupled inductor of claim 22, wherein the magnetic coupling factor between the first winding and the second winding is 99% or higher.

33. The coupled inductor of claim 22,
wherein the body has an elongated shape with a first distal end and a second distal end arranged opposite to the first distal end,
wherein the first winding has a first connection at the first distal end,
wherein the first winding has a second connection at the second distal end,
wherein the second winding has a first connection at the first distal end, and
wherein the second winding has a second connection at the second distal end.

34. The coupled inductor of claim 33, wherein the connections of the windings are arranged at the same vertical bottom position.

35. The coupled inductor of claim 22, wherein the first winding and the second winding have maximum widths at opposite distal ends of the body.

36. The coupled inductor of claim 22, wherein the first winding and the second winding are derived from a common inductance body separated into two pieces via a laser process.

37. The coupled inductor of claim 36, wherein a distance between the first winding and the second winding is d with 15 μm≤d≤50 μm.

38. The coupled inductor of claim 22, further comprising:
a magnetic core arranged within at least one of the first winding or the second winding,
wherein the magnetic core comprises magnetic particles embedded in a matrix material.

39. The coupled inductor of claim 38,
wherein the magnetic core comprises metal particles, and
wherein a dielectric material comprises or consists of a material selected from a dielectric material and an epoxy compound.

40. The coupled inductor of claim 38, wherein the matrix material is disposed via a molding process.

41. A voltage regulator comprising:
the coupled inductor according to claim 22.

42. The voltage regulator of claim 41, wherein the voltage regulator is a trans-inductor voltage regulator.

43. The voltage regulator of claim 41, wherein the voltage regulator is configured to regulate a circuit selected from an ASIC, a GPU, a CPU, or an FPGA.
